(19) United States
(12) Patent Application Publication
(10) Pub. No.: US 2024/0410984 A1
(43) Pub. Date: Dec. 12, 2024

(54) TECHNIQUES FOR PHOTONICS INPUT/OUTPUT COUPLERS FOR FMCW LIDAR

(71) Applicant: AEVA, INC., Mountain View, CA (US)

(72) Inventors: Behsan Behzadi, Sunnyvale, CA (US); Bing Shen, Sunnyvale, CA (US)

(21) Appl. No.: 18/207,370

(22) Filed: Jun. 8, 2023

(51) Int. Cl. G01S 7/481; G01S 17/32; G02B 6/42

(52) U.S. Cl. CPC G01S 7/4816; G01S 7/4817; G01S 17/32; G02B 6/4206

(57) ABSTRACT

A photonics grating coupler to transmit light in a light detection and ranging (LiDAR) system includes a receiver component adapted to receive light transmitted from an optical source. The photonics grating coupler includes a plurality of light scattering elements arranged in a rectangular pattern, wherein the plurality of light scattering elements comprises a first set of light scattering elements, each light scattering element comprising a first cross section and a first duty cycle and adapted to receive the light from the receiver to produce reflected light. The photonics grating coupler also includes a second set of light scattering elements, each light scattering element comprising a second cross section and a second duty cycle and adapted to transmit the reflected light towards a waveguide coupled to receive the reflected light.

### FIELD

The present disclosure is related to LiDAR (light detection and ranging) systems in general. One aspect of the present disclosure relates to the structure of a photonics coupler.

### BACKGROUND

Frequency-Modulated Continuous-Wave (FMCW) LiDAR systems use tunable, infrared lasers for frequency-chirped illumination of targets, and coherent receivers for detection of backscattered or reflected light from the targets that are combined with a local copy of the transmitted signal. Mixing the local copy with the return signal, delayed by the round-trip time to the target and back, generates signals at the receiver with frequencies that are proportional to the distance to each target in the field of view of the system. Electrical components and photonics components can be incorporated into one or more chips for use in a LiDAR system.

### SUMMARY

The present disclosure describes examples of systems and methods for using photonics couplers in FMCW LiDAR systems. In one embodiment of the present disclosure, an improved photonics coupler is described. In some embodiments, a photonics coupler uses a combination of apodization and scattering element duty cycle to provide a larger receive (RX) mode than transmit (TX) mode to provide more efficient coupling. In some embodiments, a photonics coupler provides an offset RX mode that reduces decoupling due to descan.

### BRIEF DESCRIPTION OF THE DRAWINGS

For a more complete understanding of various examples, reference is now made to the following detailed description taken in connection with the accompanying drawings in which like identifiers correspond to like elements:

FIG. 1 is a block diagram illustrating an example LiDAR system according to embodiments of the present disclosure;

FIG. 2 is a time-frequency diagram of an FMCW scanning signal that can be used by a LiDAR system to scan a target environment according to some embodiments;

FIG. 3 is a block diagram illustrating an example LiDAR system according to embodiments of the present disclosure;

FIG. 4 is an example illustration of an optical signal transiting a grating coupler according to embodiments of the present disclosure;

FIG. 5 is an example illustration of a grating coupler for which the receive spot (or mode) and transmit spot (or mode) size of an example LiDAR system are approximately the same, according to embodiments of the present disclosure;

FIG. 6 is an example illustration of an asymmetric grating coupler for which the receive spot (or mode) 606 is larger than the transmit spot (or mode) size, according to embodiments of the present disclosure.

FIG. 7 is an example illustration of an asymmetric grating coupler for which the receive spot (or mode) is off center with respect to the transmit spot (or mode), according to embodiments of the present disclosure.

FIG. 8 is an example illustration of an asymmetric grating coupler for which the RX spot (or mode) is off center with respect to the transmit spot (or mode) size as well as larger than the transmit mode, according to embodiments of the present disclosure.

FIG. 9 is a flow diagram of a method of operating a LiDAR system, according to embodiments of the present disclosure.

FIG. 10 is a block diagram of an example computing device that may perform one or more of the operations described herein, in accordance with aspects of the disclosure.

### DETAILED DESCRIPTION

The present disclosure describes various examples of engineering and applying photonics couplers to improve signal-to-noise ratio (SNR) and coupling efficiency. According to some embodiments, the described LiDAR system described herein may be implemented in any sensing market, such as, but not limited to, transportation, manufacturing, metrology, medical, virtual reality, augmented reality, and security systems. According to some embodiments, the described LiDAR system is implemented as part of a front-end of frequency modulated continuous-wave (FMCW) device that assists with spatial awareness for automated driver assist systems, or self-driving vehicles.

Efficiently directing light between waveguides and optical fibers can be a challenge because of a potential for mode mismatch between the optical mode within an optical fiber and the mode within the waveguide. Mode can refer to the spatial distribution of the light propagating through an optical fiber. In some embodiments, the cross-sectional area of an optical fiber (10 microns) can be almost 3000 times larger than that of a silicon waveguide (with dimensions of 500 nanometers×220 nanometers).

In some embodiments, LiDAR systems include coherent scan technology that includes the use of transmission lines, one or more sensors, receivers, and at least one local oscillator, i.e., a local copy of the transmission line. A scanning element, e.g., galvo mirror, can be used to transmit the beam of light towards targets in the field of view of a sensor used by LiDAR systems described herein. A beam reflected from the target can be collected by a lens system and combined with the local oscillator. As mirror speeds are increased, mirror movement during the round-trip time to and from a target, especially for distant targets, can cause light returned from the target to be slightly off angle with respect to a scanning mirror at the time of the arrival of the returned light at a receiver. The lag angle can result in degradation of the signal-to-noise ratio at sensors of the receiver. Using the techniques described herein, embodiments of the present invention can, among other things, address the issues described above by providing an expanded field of view of the receiver on a LiDAR system. Multiple waveguides can be provided on a substrate or photonics chip to receive returned beams having different lag angles to increase the field of view of a receiver.

Many traditional grating couplers in FMCW LiDAR systems have symmetric input/output mode sizes, e.g., the transmit (TX) and receive (RX) mode (or spot) sizes are the same. In some embodiments, this can result in lower receive coupling efficiency due to a relatively larger diffraction limited RX spot size as compared to the TX spot size. In some cases, the TX spot size can be twice as large as the RX spot size. Additionally, in some fast-scanning LiDAR systems, the RX spot can be deviated from the TX spot.

In some embodiments, a photonics coupler can comprise two sets of light scattering elements, arranged in a rectangular pattern, wherein the plurality of light scattering elements comprises: a first set of light scattering elements, each light scattering element comprising: a first cross section; and a first duty cycle; and adapted to receive the light from the receiver to produce reflected light; and a second set of light scattering elements, each light scattering element comprising: a second cross section; and a second duty cycle; and adapted to transmit the reflected light towards a waveguide coupled to receive the reflected light.

In some embodiments, the photonics coupler mode, the area of the coupler able to detect the Signal and the LO, can be sized and oriented to the size and orientation of the signal beam shape to maximize optical coupling and SNR. In some embodiments, the photonics coupler mode can also be elongated along an axis to accommodate beam lag (descan) from mechanical beam scanners.

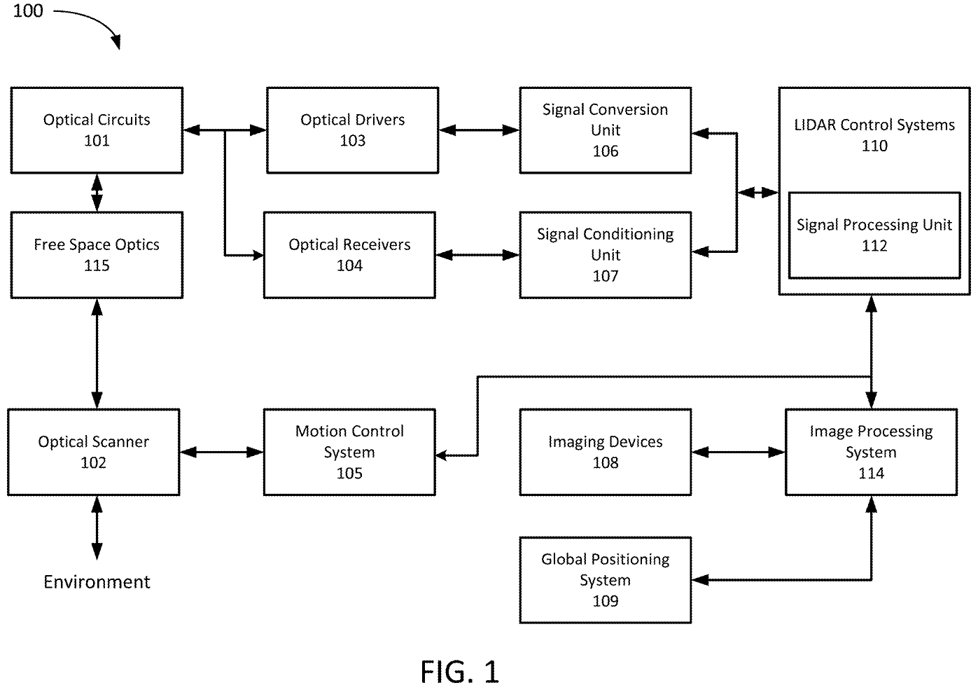

FIG. 1 is a block diagram illustrating an example LiDAR system 100 according to embodiments of the present disclosure. The LiDAR system 100 includes one or more of each of a number of components but may include fewer or additional components than shown in FIG. 1. One or more of the components depicted in FIG. 1 can be implemented on a photonics chip, according to some embodiments. The optical circuits 101 may include a combination of active optical components and passive optical components. Active optical components may generate, amplify, and/or detect optical signals and the like. In some examples, the active optical component includes optical beams at different wavelengths, and includes one or more optical amplifiers, one or more optical detectors, or the like.

Free space optics 115 may include one or more optical waveguides to carry optical signals, and route and manipulate optical signals to appropriate input/output ports of the active optical circuit. The free space optics 115 may also include one or more optical components such as taps, wavelength division multiplexers (WDM), splitters/combiners, polarization beam splitters (PBS), collimators, couplers or the like. In some examples, the free space optics 115 may include components to transform the polarization state and direct received polarized light to optical detectors using a PBS, for example. The free space optics 115 may further include a diffractive element to deflect optical beams having different frequencies at different angles along an axis, e.g., a fast-axis.

In some examples, the LiDAR system 100 includes an optical scanner 102 that includes one or more scanning mirrors that are rotatable along an axis, e.g., a slow-axis, that is orthogonal or substantially orthogonal to the fast-axis of the diffractive element to steer optical signals to scan an environment according to a scanning pattern. For instance, the scanning mirrors may be rotatable by one or more galvanometers. Objects in the target environment may scatter an incident light into a return optical beam or a target return signal. The optical scanner 102 also collects the return optical beam or the target return signal, which may be returned to the passive optical circuit component of the optical circuits 101. For example, the return optical beam may be directed to an optical detector by a polarization beam splitter. In addition to the mirrors and galvanometers, the optical scanner 102 may include components such as a quarter-wave plate, lens, anti-reflective coated window or the like.

To control and support the optical circuits 101 and optical scanner 102, the LiDAR system 100 includes LiDAR control systems 110. The LiDAR control systems 110 may include a processing device for the LiDAR system 100. In some examples, the processing device may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

In some examples, the LiDAR control systems 110 may include a signal processing unit 112 such as a DSP. The LiDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuits 101 to drive optical sources such as lasers and amplifiers. In some examples, several optical drivers 103 and signal conversion units 106 may be provided to drive multiple optical sources.

The LiDAR control systems 110 are also configured to output digital control signals for the optical scanner 102. A motion control system 105 may control the galvanometers of the optical scanner 102 based on control signals received from the LiDAR control systems 110. For example, a digital-to-analog converter may convert coordinate routing information from the LiDAR control systems 110 to signals interpretable by the galvanometers in the optical scanner 102. In some examples, a motion control system 105 may also return information to the LiDAR control systems 110 about the position or operation of components of the optical scanner 102. For example, an analog-to-digital converter may in turn convert information about the galvanometers' position to a signal interpretable by the LiDAR control systems 110.

The LiDAR control systems 110 are further configured to analyze incoming digital signals. In this regard, the LiDAR system 100 includes optical receivers 104 to measure one or more beams received by optical circuits 101. For example, a reference beam receiver may measure the amplitude of a reference beam from the active optical component, and an analog-to-digital converter converts signals from the reference receiver to signals interpretable by the LiDAR control systems 110. Target receivers within the optical receivers 104 measure the optical signal that carries information about the range and velocity of a target in the form of a beat frequency, a modulated optical signal. The reflected beam may be mixed with a second signal from a local oscillator. The optical receivers 104 may include a high-speed analog-to-digital converter to convert signals from the target receiver to signals interpretable by the LiDAR control systems 110. In some examples, the signals from the optical receivers 104 may be subject to signal conditioning by signal conditioning unit 107 prior to receipt by the LiDAR control systems 110. For example, the signals from the optical receivers 104 may be provided to an operational amplifier for amplification of the received signals and the amplified signals may be provided to the LiDAR control systems 110.

In some applications, the LiDAR system 100 may additionally include one or more imaging devices 108 configured to capture images of the environment, a global positioning system 109 configured to provide a geographic location of the system, or other sensor inputs. The LiDAR system 100 may also include an image processing system 114. The image processing system 114 can be configured to receive the images and geographic location, and send the images and location or information related thereto to the LiDAR control systems 110 or other systems connected to the LiDAR system 100.

In operation according to some examples, the LiDAR system 100 is configured to use nondegenerate optical sources to simultaneously measure range and velocity across two dimensions. This capability allows for real-time, long-range measurements of range, velocity, azimuth, and elevation of the surrounding environment.

In some examples, the scanning process begins with the optical drivers 103 and LiDAR control systems 110. The LiDAR control systems 110 instruct, e.g., via signal processor unit 112, the optical drivers 103 to independently modulate one or more optical beams, and these modulated signals propagate through the optical circuits 101 to the free space optics 115. The free space optics 115 directs the light at the optical scanner 102 that scans a target environment over a preprogrammed pattern defined by the motion control system 105. The optical circuits 101 may also include a polarization wave plate (PWP) to transform the polarization of the light as it leaves the optical circuits 101. In some examples, the polarization wave plate may be a quarter-wave plate or a half-wave plate. A portion of the polarized light may also be reflected back to the optical circuits 101. For example, lensing or collimating systems used in LiDAR system 100 may have natural reflective properties or a reflective coating to reflect a portion of the light back to the optical circuits 101.

Optical signals reflected back from an environment pass through the optical circuits 101 to the optical receivers 104. Because the polarization of the light has been transformed, it may be reflected by a polarization beam splitter along with the portion of polarized light that was reflected back to the optical circuits 101. In such scenarios, rather than returning to the same fiber or waveguide serving as an optical source, the reflected signals can be reflected to separate optical receivers 104. These signals interfere with one another and generate a combined signal. The combined signal can then be reflected to the optical receivers 104. Also, each beam signal that returns from the target environment may produce a time-shifted waveform. The temporal phase difference between the two waveforms generates a beat frequency measured on the optical receivers 104, e.g., photodetectors.

The analog signals from the optical receivers 104 are converted to digital signals by the signal conditioning unit 107. These digital signals are then sent to the LiDAR control systems 110. A signal processing unit 112 may then receive the digital signals to further process and interpret them. In some embodiments, the signal processing unit 112 also receives position data from the motion control system 105 and galvanometers (not shown) as well as image data from the image processing system 114. The signal processing unit 112 can then generate 3D point cloud data that includes information about range and/or velocity points in the target environment as the optical scanner 102 scans additional points. The signal processing unit 112 can also overlay 3D point cloud data with image data to determine velocity and/or distance of objects in the surrounding area. The signal processing unit 112 also processes the satellite-based navigation location data to provide data related to a specific global location.

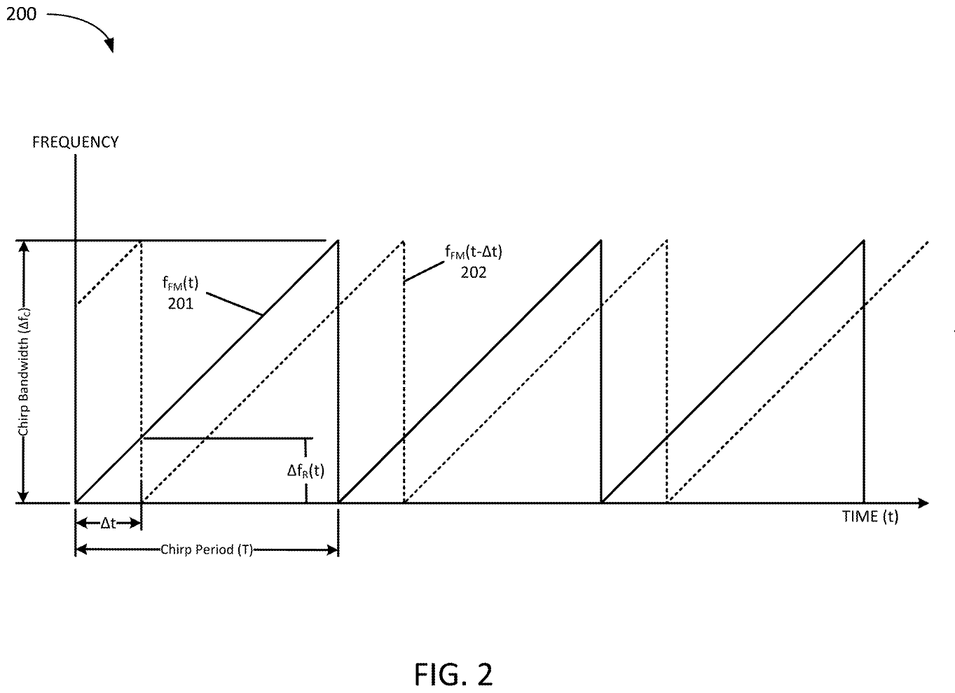

FIG. 2 is a time-frequency diagram 200 of an FMCW scanning signal 201 that can be used by a LiDAR system, such as system 100, to scan a target environment according to some embodiments. In one example, the scanning waveform 201, labeled as f_{FM}(t), is a sawtooth waveform (sawtooth “chirp”) with a chirp bandwidth Δf_{C} and a chirp period T_{C}. The slope of the sawtooth is given as k=(Δf_{C}/T_{C}). FIG. 2 also depicts target return signal 202 according to some embodiments. Target return signal 202, labeled as f_{FM}(t−Δt), is a time-delayed version of the scanning signal 201, where Δt is the round-trip time to and from a target illuminated by scanning signal 201. The round-trip time is given as Δt=2R/ν, where R is the target range and ν is the velocity of the optical beam, which is the speed of light c. The target range, R, can therefore be calculated as R=c(Δt/2). When the return signal 202 is optically mixed with the scanning signal, a range dependent difference frequency (“beat frequency”) Δf_{R}(t) is generated. The beat frequency Δf_{R}(t) is linearly related to the time delay Δt by the slope of the sawtooth k. That is, Δf_{R}(t)=kΔt. Since the target range R is proportional to Δt, the target range R can be calculated as R=(c/2)(Δf_{R}(t)/k). That is, the range R is linearly related to the beat frequency Δf_{R}(t). The beat frequency Δf_{R}(t) can be generated, for example, as an analog signal in optical receivers 104 of system 100. The beat frequency can then be digitized by an analog-to-digital converter (ADC), for example, in a signal conditioning unit such as signal conditioning unit 107 in LiDAR system 100. The digitized beat frequency signal can then be digitally processed, for example, in a signal processing unit, such as signal processing unit 112 in system 100. It should be noted that the target return signal 202 will, in general, also includes a frequency offset (Doppler shift) if the target has a velocity relative to the LiDAR system 100. The Doppler shift can be determined separately and used to correct the frequency of the return signal, so the Doppler shift is not shown in FIG. 2 for simplicity and ease of explanation. It should also be noted that the sampling frequency of the ADC will determine the highest beat frequency that can be processed by the system without aliasing. In general, the highest frequency that can be processed is one-half of the sampling frequency, i.e., the “Nyquist limit”. In some embodiments, if the sampling frequency of the ADC is 1 gigahertz, then the highest beat frequency that can be processed without aliasing (Δf_{Rmax}) is 500 megahertz. This limit in turn determines the maximum range of the system as Rₘₐₓ=(c/2)(Δf_{Rmax}/k) which can be adjusted by changing the chirp slope k. In one example, while the data samples from the ADC may be continuous, the subsequent digital processing described below may be partitioned into “time segments” that can be associated with some periodicity in the LiDAR system 100. In some embodiments, a time segment might correspond to a predetermined number of chirp periods T, or a number of full rotations in azimuth by the optical scanner.

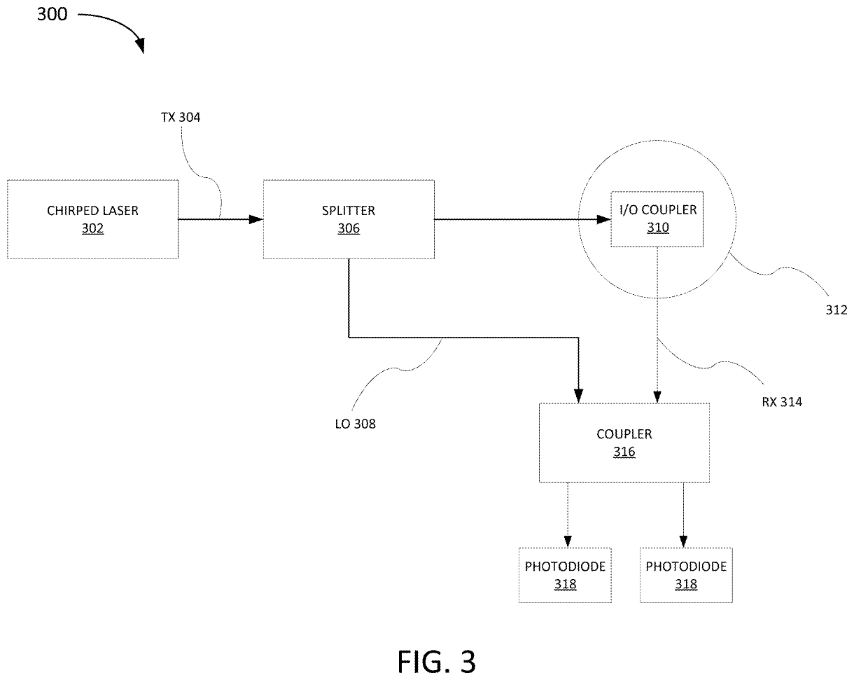

Embodiments described below with respect to FIGS. 3-10 may be used, at least in part, to produce and operate an FMCW LiDAR system as described with respect to FIGS. 1 and 2 above.

FIG. 3 is a block diagram illustrating an example LiDAR system 300 according to embodiments of the present disclosure. In the example, a chirped laser 302 transmits a beam 304 (TX) that passes through an I/O coupler 310 and then through a collimating lens 312 towards a target. In some embodiments, the outgoing beam may pass through a Faraday rotator to rotate the polarization. In some embodiments, a waveplate is used to rotate the polarization. In some embodiments, a scanning element, e.g., a scanning mirror, polygon, or a combination, is placed in front of the outgoing beam to steer the field-of-view (FOV) of the sensor. In some embodiments, a portion of the transmitted beam 304 is diverted as local oscillator 308. Upon reflection from a target, a received (RX) signal 314 is delivered to a coupler 316. In some embodiments, the received signal 314 is mixed with the local oscillator 308 by the coupler 316. In some embodiments, the I/O coupler 310 is a grating coupler. In some embodiments, one or more outputs of the coupler 316 may be consumed by photodiodes 318.

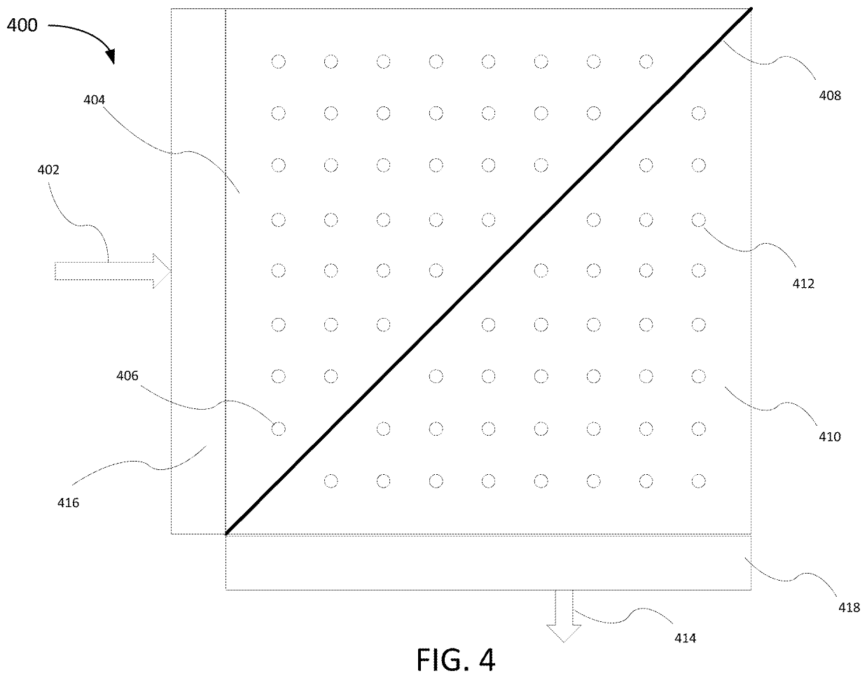

FIG. 4 is an example illustration of an optical signal transiting a photonics grating coupler 400 according to embodiments of the present disclosure. An optical signal 402 enters the photonics grating coupler 400. In some embodiments, a waveguide 416 can direct the refracted optical signal 402. The photonics grating coupler 400 can be divided, by a diagonal 408, into two triangular regions 404 and 410. Within the triangular region 404, the optical signal is refracted by a set of scattering elements 406. The optical signal is refracted by the diagonal 408 into triangular region 410 where it is further refracted by a second set of scattering elements 412. The refracted optical signal 414 then exits the photonics grating coupler 400. In some embodiments, the scattering elements can have a circular cross section. In some embodiments, the scattering elements can have a rectangular cross section. In some embodiments, the cross section of the scattering elements can be that of a four-sided polygon. In some embodiments, the distance between scattering elements can vary. In some embodiments, the cross areas of the scattering elements can vary. In some embodiments, a waveguide 418 can direct the refracted optical signal 414.

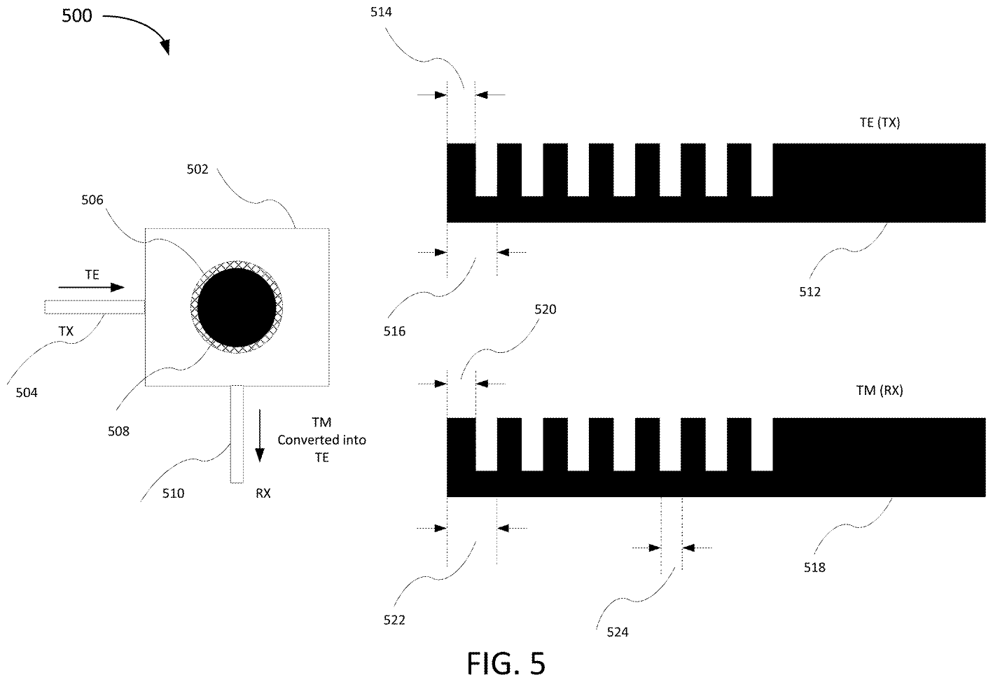

FIG. 5 is an example illustration of a grating coupler 502 for which the receive spot (or mode) 506 and transmit spot (or mode) size 508 of an example LiDAR system are approximately the same, according to embodiments of the present disclosure. In some embodiments, grating coupler 502 may correspond to grating coupler 400 of FIG. 4. Transverse electric (TE) modes can be defined as these modes having their electric fields perpendicular to the plane of incidence and transverse magnetic (TM) modes can be defined as those modes having their magnetic fields perpendicular to the plane of incidence. In the example, the TX path 504 is transmitted through a TE mode. In the example, the TM mode 510 is used to collect the reflected beam from the target. A Faraday rotator or waveplate can provide more efficient conversion between the TX and RX. In some embodiments, the grating coupler can convert TM to TE.

FIG. 5 also shows an orientation of the scattering elements within two regions of a grating coupler. In the example, the arrangement of scattering elements 512 (receiving the TX signal) corresponds to triangular region 404 of FIG. 4. The scattering elements have a duty cycle 514. The duty cycle of a region of a grating coupler can be defined as the width of the grating tooth, or scattering element, of that region. The scattering elements also have a grating period 516, which represents the length of the periodic pattern between scattering elements. In the example, the duty cycle 514 and grating period 516 are constant across the TX region 512 of the grating coupler and the RX region 518 of the grating coupler.

FIG. 5 also shows an orientation of the scattering elements within the RX region of the grating coupler. In the example, the arrangement of scattering elements 518 (receiving the RX signal) corresponds to triangular region 410 of FIG. 4. RX region 518 has a duty cycle 520 and a grating period 522. In the example duty cycle 520 is equal to duty cycle 514 and grating period 522 is equal to grating period 516. Kappa 524 is also indicated in the example, which is the difference between the grating period and the duty cycle. In the example, kappa 524 is constant for both the TX region 512 and the RX region 518.

In some embodiments the mode of the signal beam is elliptical. The mode of the signal beam can also be spherical. In some embodiments, the shape of the photonics coupler mode can be designed to match that of the anticipated signal mode.

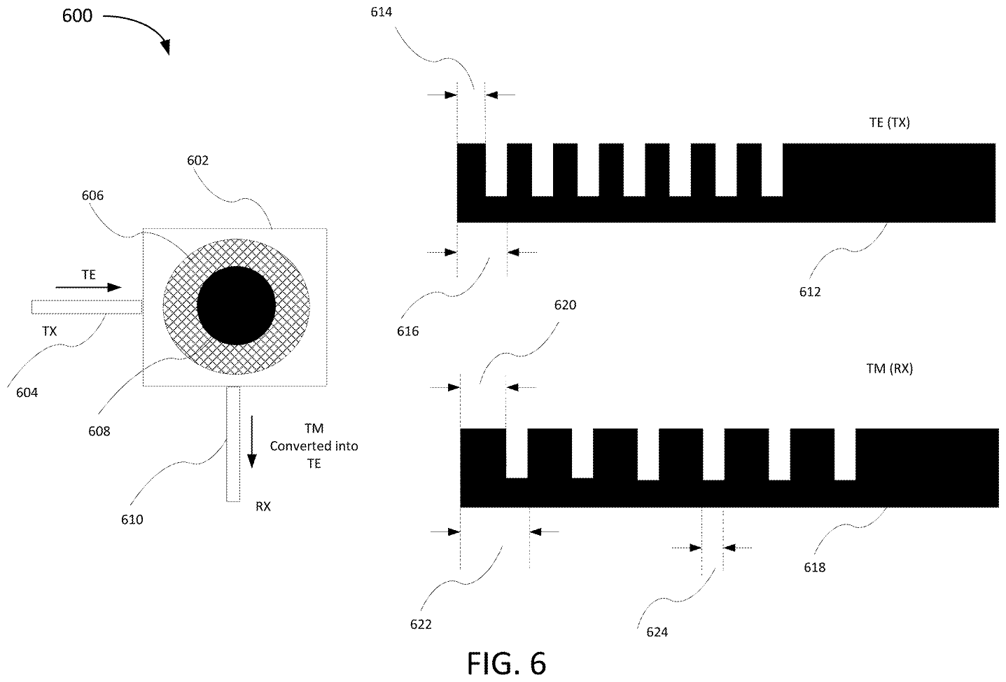

FIG. 6 is an example illustration 600 of an asymmetric grating coupler 602 for which the receive spot (or mode) 606 is larger than the transmit spot (or mode) size 608, according to embodiments of the present disclosure. In the example, receive mode 606 is obtained from RX 610 and transmit mode 608 is obtained from TX 604.

FIG. 6 also shows an orientation of the scattering elements within two regions of a grating coupler producing this difference in mode sizes. In the example, the arrangement of scattering elements 612 (receiving the TX signal) corresponds to triangular region 404 of FIG. 4. The scattering elements have a duty cycle 614. The scattering elements also have a grating period 616. In the example 600, the duty cycle 614 and grating period 616 are constant across the TX region 612 of the grating coupler.

However, as compared to the duty cycles and grating periods of FIG. 5, the scattering elements of region 618, the RX section of the grating coupler, the duty cycle 620 is larger. In some embodiments, the grating period 622 is larger. In some embodiments, kappa 624 can remain the same as kappa 524 of the symmetric grating coupler of FIG. 5. In the example, kappa 624 remains constant across the grating coupler region 618. In some embodiments, kappa 624 can be smaller than that of region 612. As a result of the larger duty cycle 620, a larger mode size 606 can be produced. In some embodiments, higher coupling efficiency can be obtained between the TX mode size 608 and RX mode size 606 as a result of the larger RX mode size 606.

A mechanical scanner can be placed in the Tx beam path. If the scanning motion is appreciably faster than the time it takes for the beam of light to return back to the system from a reflected target, the return beam can be slightly deflected on the final Rx. In some embodiments, as the scan speed and target distance increase, this deflection, or “descan,” can also increase. In a LiDAR system, this can lead to misalignment of LO and signal beams, lowering the overall mixing efficiency and SNR. In some embodiments, the photonics coupler mode can be elongated along the descan axis to mitigate this mode mismatch. While, in some embodiments, this reduces the coupling efficiency for a specific signal beam position, it can improve the overall coupling efficiency for a system comprising multiple scanning speeds and target distances.

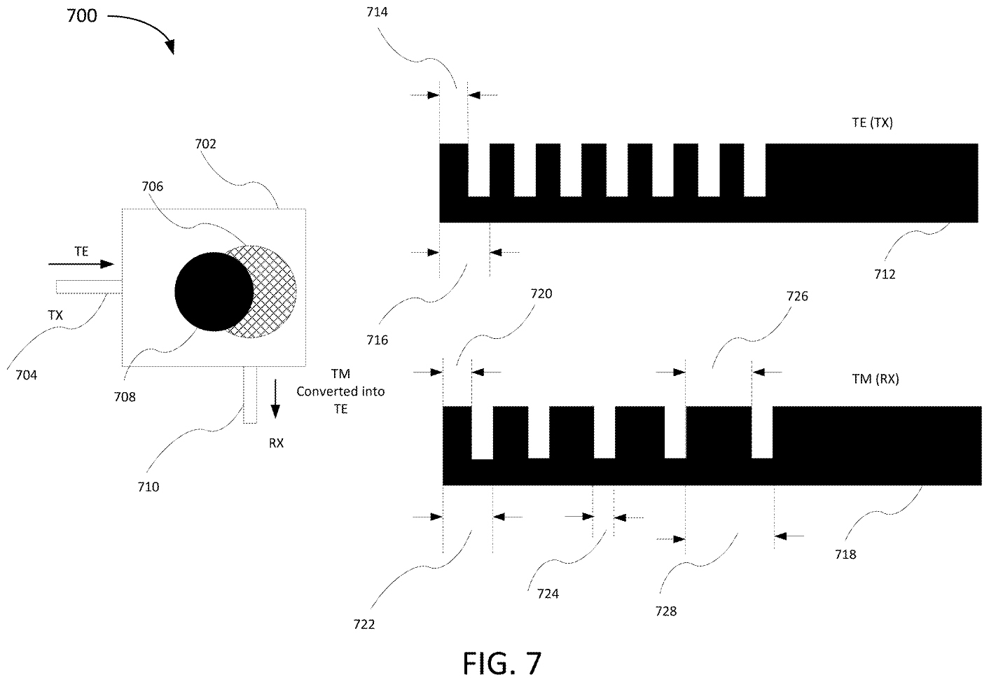

FIG. 7 is an example illustration 700 of an asymmetric grating coupler 702 for which the receive spot (or mode) 706 is off center with respect to the transmit spot (or mode) 708, according to embodiments of the present disclosure. In the example, receive mode 706 is obtained from RX 710 and transmit mode 708 is obtained from TX 704.

FIG. 7 also shows an orientation of the scattering elements within two regions of a grating coupler producing this difference in mode orientation. In the example, the arrangement of scattering elements 712 (receiving the TX signal) corresponds to triangular region 404 of FIG. 4. The scattering elements have a duty cycle 714. The scattering elements also have a grating period 716. In the example 700, the duty cycle 714 and grating period 716 are constant across the TX region 712 of the grating coupler.

However, as compared to the duty cycles and grating periods of FIG. 7, the scattering elements of region 718, the RX section of the grating coupler, the duty cycle 720 increases with distance from the diagonal, represented by the left side of the RX region 718. This increase of duty cycle over distance is called apodization. Apodization can be defined as a gradual tapering of diffractive steps from an inner edge towards an outside edge to create a smooth transition of light between the distance, intermediate and near focal points. In some embodiments, the grating period 722 can increase. In some embodiments, kappa 724 can remain constant and remain the same as kappa 724 of the symmetric grating coupler of FIG. 7. In the example, kappa 724 remains constant across the grating coupler region 718. In some embodiments, kappa 724 can be smaller than that of region 712. In the example, duty cycle 726 is larger than duty cycle 720. As a result of the apodization, receive mode 706 can be offset from transmit mode 708. In some embodiments, the offset of the RX mode size can reduce decoupling due to descan.

It can be advantageous to combine apodization and scattering element duty cycle to provide both a larger receive (RX) mode than transmit (TX) mode as well as an offset RX mode to provide improved coupling and mitigate descan.

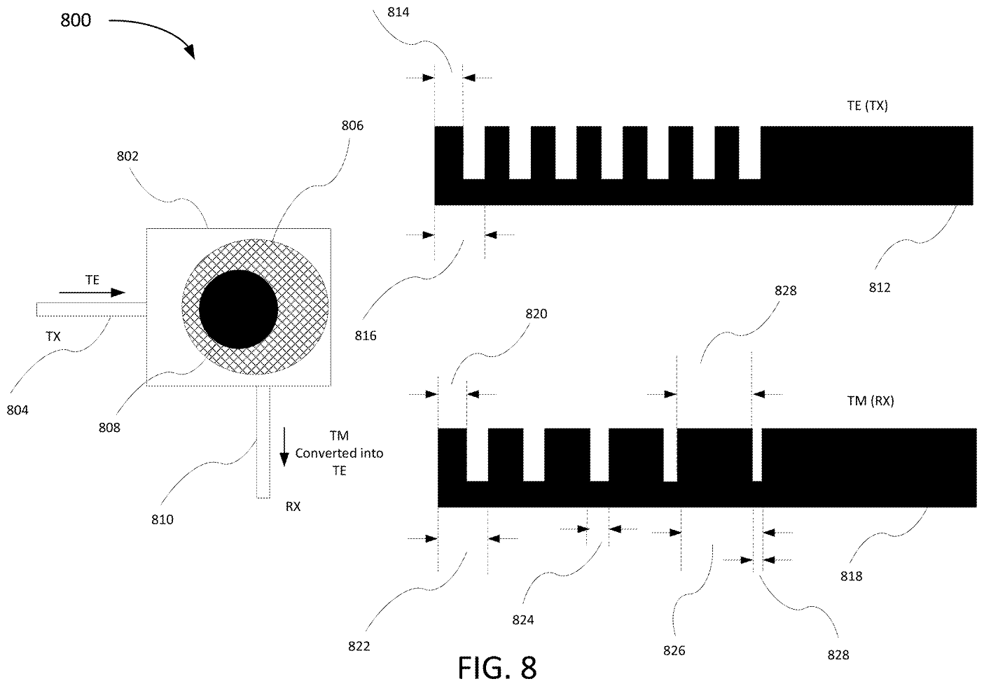

FIG. 8 is an example illustration 800 of an asymmetric grating coupler 802 for which the RX spot (or mode) 806 is off center with respect to the transmit spot (or mode) size 808 as well as larger than the transmit mode 808, according to embodiments of the present disclosure. In the example, receive mode 806 is obtained from RX 810 and transmit mode 808 is obtained from TX 804

In the example, TX 812 may correspond to region 504 of FIG. 5 and RX 810 may correspond to 510 of FIG. 5. In the example, the arrangement of scattering elements 812 (receiving the TX signal) corresponds to triangular region 404 of FIG. 4. The scattering elements have a duty cycle 814. The scattering elements also have a grating period 816. In the example 800, the duty cycle 814 and grating period 816 are constant across the TX region 812 of the grating coupler.

However, as compared to the invariable duty cycles and grating periods of FIG. 5, the scattering elements of region 818, the RX section of the grating coupler, the duty cycle 820 is apodised, as represented by the left side of the RX region 818. In some embodiments, the grating period 822 can increase. In some embodiments, kappa 824 also decreases as the scattering elements are placed further from the diagonal. In some embodiments, duty cycle can also increase with distance from the diagonal. In the example, duty cycle 828 is larger than duty cycle 820. In the example, grating period 826 is larger than grating period 822. In the example, kappa 828 is smaller than kappa 824. As a result of the combination of the apodization and the larger duty cycles of the scattering elements, receive mode 806 can be both larger than transmit mode 808 and offset from transmit mode 808. In some embodiments, the larger RX mode can allow for more efficient coupling (and a higher signal-to-noise ratio) of the RX beam into the LiDAR system, and the offset of the RX mode can reduce decoupling due to descan.

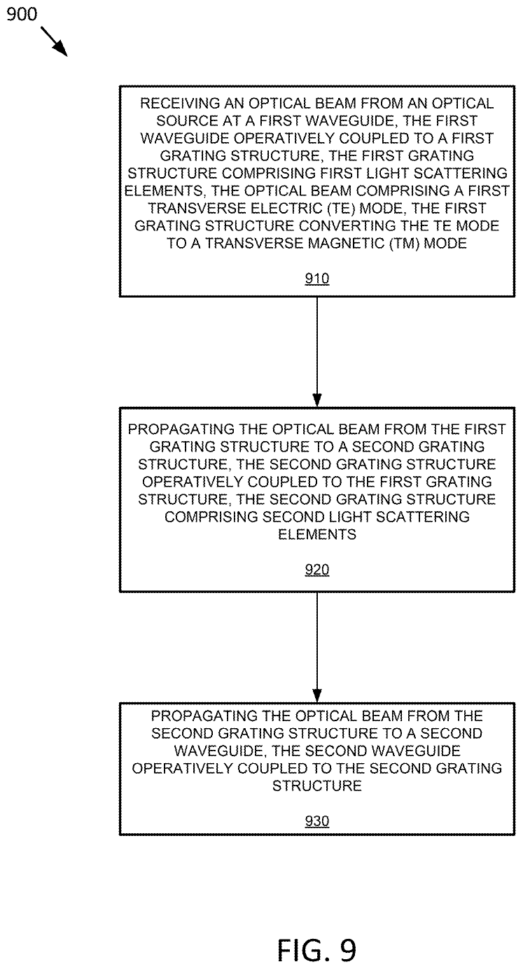

FIG. 9 is a flow diagram 900 of a method of operating a LiDAR system, according to embodiments of the present disclosure.

Method 900 begins at block 910, where an optical beam is received from an optical source at a first waveguide. In some embodiments, the optical beam may correspond to optical beam 402 of FIG. 4. In some embodiments, the first waveguide may correspond to waveguide 416 of FIG. 4. The first waveguide is operatively coupled to a first grating structure, the first grating structure comprising first light scattering elements. In some embodiments, the first grating structure may correspond to region 404 of FIG. 4. In some embodiments, the first light scattering elements may correspond to scattering elements 406 of FIG. 4. The optical beam comprises a first transverse electric (TE) mode. The first grating structure converts the TE mode to a transverse magnetic (TM) mode.

At block 920, the method propagates the optical beam from the first grating structure to a second grating structure, the second grating structure operatively coupled to the first grating structure, the second grating structure comprising second light scattering elements. In some embodiments, the second grating structure may correspond to region 410 of FIG. 4. In some embodiments, the second light scattering elements may correspond to scattering elements 412 of FIG. 4.

At block 930, the method propagates the optical beam from the second grating structure to a second waveguide, the second waveguide operatively coupled to the second grating structure. In some embodiments, the second grating structure may correspond to region 610 of FIG. 6. In some embodiments, the second waveguide may correspond to waveguide 618 of FIG. 6.

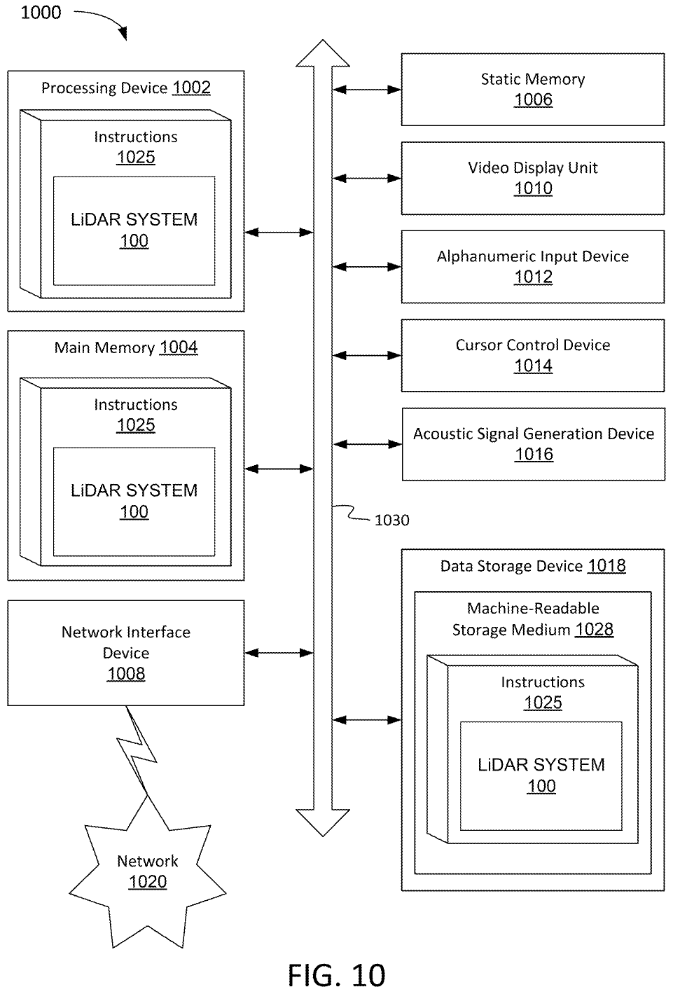

FIG. 10 is a block diagram 1000 of an example computing device that may perform one or more of the operations described herein, in accordance with aspects of the disclosure. Computing device 1000 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 1000 may include a processing device, e.g., a general-purpose processor, a programmable-logic device (PLD), etc., 1002, a main memory 1004, e.g., synchronous dynamic random-access memory (DRAM) or read-only memory (ROM), a static memory 1006, e.g., flash memory, and a data storage device 1018, which may communicate with each other via a bus 1030.

Processing device 1002 may be provided by one or more general-purpose processing devices such as a microprocessor, central processing unit, or the like. In an illustrative example, processing device 1002 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 1002 may also include one or more special-purpose processing devices such as an application specific integrated circuit (ASIC), a field programmable gate array (FPGA), a digital signal processor (DSP), network processor, or the like. The processing device 1002 may execute the operations described herein, in accordance with one or more aspects of the present disclosure, for performing the operations and steps discussed herein.

Computing device 1000 may further include a network interface device 1008 which may communicate with a network 1020. The computing device 1000 also may include a video display unit 1010, e.g., a liquid crystal display (LCD) or a cathode ray tube (CRT), an alphanumeric input device 1012, e.g., a keyboard, a cursor control device 1014, e.g., a mouse, and an acoustic signal generation device 1016, e.g., a speaker. In one embodiment, video display unit 1010, alphanumeric input device 1012, and cursor control device 1014 may be combined into a single component or device, e.g., an LCD touch screen.

Data storage device 1018 may include a computer-readable storage medium 1028 on which may be stored one or more sets of instructions 1025 that may include instructions for tuning the LiDAR system 100 described herein, in accordance with one or more aspects of the present disclosure. The instructions 1025 for the LiDAR system 100 may also reside, completely or at least partially, within main memory 1004 and/or within processing device 1002 during execution thereof by computing device 1000, main memory 1004 and processing device 1002 also constituting computer-readable media. The instructions 1025 for LiDAR system 100 may further be transmitted or received over a network 1020 via network interface device 1008.

While computer-readable storage medium 1028 is shown in an illustrative example to be a single medium, the term “computer-readable storage medium” should be taken to include a single medium or multiple media, e.g., a centralized or distributed database and/or associated caches and servers, that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

The preceding description sets forth numerous specific details such as examples of specific systems, components, methods, and so forth, in order to provide a thorough understanding of several examples in the present disclosure. It will be apparent to one skilled in the art, however, that at least some examples of the present disclosure may be practiced without these specific details. In other instances, well-known components or methods are not described in detail or are presented in simple block diagram form in order to avoid unnecessarily obscuring the present disclosure. Thus, the specific details set forth are merely exemplary. Particular examples may vary from these exemplary details and still be contemplated to be within the scope of the present disclosure.

Any reference throughout this specification to “one example” or “an example” means that a particular feature, structure, or characteristic described in connection with the examples are included in at least one example. Therefore, the appearances of the phrase “in one example” or “in an example” in various places throughout this specification are not necessarily all referring to the same example.

Although the operations of the methods herein are shown and described in a particular order, the order of the operations of each method may be altered so that certain operations may be performed in an inverse order or so that certain operation may be performed, at least in part, concurrently with other operations. Instructions or sub-operations of distinct operations may be performed in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Furthermore, the terms “first,” “second,” “third,” “fourth,” etc. as used herein are meant as labels to distinguish among different elements and may not necessarily have an ordinal meaning according to their numerical designation.

What is claimed is:

1. A photonics grating coupler to transmit light in a light detection and ranging (LiDAR) system, the LiDAR system comprising:
a receiver component adapted to receive light transmitted from an optical source;
a plurality of light scattering elements, wherein the plurality of light scattering elements comprises:
a set of first light scattering elements, wherein each element of the set of first light scattering elements is adapted to receive the light from the receiver component to produce reflected light; and
a set of second light scattering elements, wherein each element of the set of second light scattering elements is adapted to transmit the reflected light towards a waveguide coupled to receive the reflected light.

2. The photonics grating coupler of claim 1, wherein the LiDAR system is a frequency-modulated continuous wave (FMCW) LiDAR system.

3. The photonics grating coupler of claim 1, wherein a boundary between the set of first light scattering elements and the set of second light scattering elements extends diagonally on the photonics grating coupler.

4. The photonics grating coupler of claim 1, wherein a first cross section of a first element of the set of first light scattering elements is decreased relative to a second cross section of a second element of the set of second light scattering elements to increase a mode size of the light received from the optical source to produce a transverse magnetic (TM) portion of the light at a first position of the photonics grating coupler.

5. The photonics grating coupler of claim 4, wherein the first cross section is circular.

6. The photonics grating coupler of claim 4, wherein the light scattering elements of the set of second light scattering elements are apodised.

7. The photonics grating coupler of claim 1, wherein a first duty cycle of the set of first light scattering elements is less than a second duty cycle of the set of second light scattering elements.

8. An asymmetric photonics grating coupler for a scanning frequency-modulated continuous wave (FMCW) light detection and ranging (LiDAR) system, comprising a plurality of grating structures, the plurality of grating structures comprising a transmission (TX) grating structure and a receiver (RX) grating structure, the TX grating structure and the RX grating structure comprising respective scattering elements, wherein the RX grating structure and the TX grating structure are configured such that:
the center of a TM mode of an optical beam received by the grating coupler and the center of the TE mode of the optical beam are aligned along a receiving (RX) axis, the RX axis perpendicular to a first waveguide; and
the TM mode is larger than the TE mode.

9. The asymmetric photonics grating coupler of claim 8, wherein the asymmetric photonics grating coupler is an asymmetric coaxial photonics grating coupler.

10. The asymmetric photonics grating coupler of claim 8, wherein the TM mode is deviated from the TE mode along a transmission (TX) axis.

11. The asymmetric photonics grating coupler of claim 10, wherein the TX axis is perpendicular to a second waveguide.

12. The asymmetric photonics grating coupler of claim 8, wherein:
the asymmetric photonics grating coupler is rectangular; and
the asymmetric photonics grating coupler is divided into two regions by a diagonal, wherein a first region of the two regions comprises the TX grating structure and a second region of the two regions comprises the RX grating structure, the two regions operatively connected.

13. The asymmetric photonics grating coupler of claim 12, wherein each of the two regions is a congruent right triangle and the two regions are operatively connected along their respective hypotenuses.

14. The asymmetric photonics grating coupler of claim 8, wherein the scattering elements of the TX grating structure have a different shape than the scattering elements of the RX grating structure.

15. A method of adjusting a size and an alignment of a transverse electric (TE) mode spot and a size and an alignment of a transverse magnetic (TM) mode spot using an asymmetric photonics grating coupler for a scanning frequency-modulated continuous wave (FMCW) light detection and ranging (LiDAR) system, comprising:
receiving an optical beam from an optical source at a first waveguide, the first waveguide operatively coupled to a first grating structure, the first grating structure comprising first light scattering elements, the optical beam comprising a transverse electric (TE) mode, the first grating structure converting the TE mode to a transverse magnetic (TM) mode;
propagating the optical beam from the first grating structure to a second grating structure, the second grating structure operatively coupled to the first grating structure, the second grating structure comprising second light scattering elements; and
propagating the optical beam from the second grating structure to a second waveguide, the second waveguide operatively coupled to the second grating structure.

16. The method of claim 15, wherein the second grating structure causes a spot associated with the TM mode to have a greater diameter than a spot associated with the TE mode.

17. The method of claim 15, wherein the second grating structure causes a spot associated with the TM mode to be offset from a spot associated with the TE mode.

18. The method of claim 15, wherein the second grating structure provides a smaller duty cycle than the first grating structure.

19. The method of claim 15, wherein the first waveguide is on a different epitaxial layer of the asymmetric photonics grating coupler than the second waveguide.

20. The method of claim 15, wherein the TM mode is deviated from the TE mode along a transmission (TX) axis.
